(19) United States
(12) Patent Application Publication
(10) Pub. No.: US 2017/0187568 A1
(43) Pub. Date: Jun. 29, 2017

(54) APPARATUS AND METHOD TO IDENTIFY A RANGE AFFECTED BY A FAILURE OCCURRENCE

(71) Applicant: FUJITSU LIMITED, Kawasaki-shi (JP)

(72) Inventor: Masahiro Sato, Yokohama (JP)

(73) Assignee: FUJITSU LIMITED, Kawasaki-shi (JP)

(21) Appl. No.: 15/378,713

(22) Filed: Dec. 14, 2016

(30) Foreign Application Priority Data
Dec. 24, 2015 (JP) 2015-252396

(51) Int. Cl. H04L 12/24; H04L 12/703

(52) U.S. Cl. CPC H04L 41/0677; H04L 41/12; H04L 45/28

(57) ABSTRACT

An apparatus holds information on an information processing system including plural information processing devices and plural relay devices that relay communication between the plural information processing devices. The apparatus groups the plural information processing devices into groups each including one or more information processing devices which are each coupled via one link to an identical set of edge relay devices common to all the one or more information processing devices. Upon being provided with information on a failure that has occurred in the information processing system, the apparatus identifies an inter-group communication between a pair of groups affected by the failure with reference to information on communication paths each coupling the pair of groups, and identifies an inter-device communication between a pair of information processing devices that is affected by the failure, with reference to information on the identified inter-group communication and information processing devices in the pair of groups.

### CROSS-REFERENCE TO RELATED APPLICATION

This application is based upon and claims the benefit of priority of the prior Japanese Patent Application No. 2015-252396, filed on Dec. 24, 2015, the entire contents of which are incorporated herein by reference.

### FIELD

The embodiments discussed herein are related to apparatus and method to identify a range affected by a failure occurrence.

### BACKGROUND

A cloud system is constructed of a number of servers, switches, and the like and thus has a complex configuration in order to implement a service offering to multiple users. When a failure has occurred in such a complex environment, a cloud management device that manages a cloud system identifies customers who are affected by the failure, based on physical path information stored in advance and configuration information of a virtual system, in order to support cloud service providers.

Note that there is a technique in which, when network identifiers for routing are associated with respective computer identifiers, a plurality of computers that execute a program in parallel are grouped for each lowest-level relay device among relay devices in a hierarchical configuration, the groups are sorted, and identifiers are assigned to the computers according to the sorting order.

An example of the related art is Japanese Laid-open Patent Publication No. 2012-98881.

### SUMMARY

According to an aspect of the invention, an apparatus holds information on an information processing system including a plurality of information processing devices and a plurality of relay devices that relay communication between the information processing devices. With reference to the information, the apparatus groups the plurality of information processing devices into groups each including one or more information processing devices which are each coupled via one link to an identical set of edge relay devices common to all the one or more information processing devices. Upon being provided with information on a failure that has occurred in the information processing system, the apparatus identifies an inter-group communication between a pair of groups affected by the failure with reference to information on communication paths each coupling the pair of groups, and identifies an inter-device communication between a pair of information processing devices that is affected by the failure, with reference to information on the identified inter-group communication and information on information processing devices in the pair of groups.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing system, according to an embodiment;

FIG. 2 is a diagram illustrating an example of a functional configuration of a cloud management device, according to an embodiment;

FIG. 3 is a diagram illustrating an example of a redundancy management table, according to an embodiment;

FIG. 4 is a diagram illustrating an example of a coupling link management table, according to an embodiment;

FIG. 5 is a diagram illustrating an example of a VM management table, according to an embodiment;

FIG. 6 is a diagram illustrating an example of a server management table, according to an embodiment;

FIG. 7 is a diagram illustrating an example of a server group management table, according to an embodiment;

FIG. 8 is a diagram illustrating an example of a target system used for FIG. 6 and FIG. 7, according to an embodiment;

FIG. 9A is a diagram illustrating an example of group assignment, according to an embodiment;

FIG. 9B is a diagram illustrating an example of group assignment, according to an embodiment;

FIG. 10 is a diagram illustrating an example of a physical path table, according to an embodiment;

FIG. 11 is a diagram illustrating an example of identification of an affected range in consideration of a redundant path, according to an embodiment;

FIG. 12A is a diagram illustrating an example of identification of an affected range when a failure has occurred in a path between a server and an edge switch, according to an embodiment;

FIG. 12B is a diagram illustrating an example of identification of an affected range when a failure has occurred in a path between a server and an edge switch, according to an embodiment;

FIG. 13 is a diagram illustrating an example of an operational flowchart for a process of creating a server group, according to an embodiment;

FIG. 14 is a diagram illustrating an example of an operational flowchart for a process of creating a physical path table, according to an embodiment;

FIG. 15A is a diagram illustrating an example of an operational flowchart for a process of identifying an affected range, according to an embodiment;

FIG. 15B is a diagram illustrating an example of an operational flowchart for a process of identifying an affected range, according to an embodiment;

FIG. 16 is a diagram illustrating an example of an information processing system that is used for explaining an example of identification of an affected range, according to an embodiment;

FIG. 17 is a diagram illustrating an example of a redundant management table, a coupling link management table, and a VM management table corresponding to the information processing system illustrated in FIG. 16, according to an embodiment;

FIG. 18 is a diagram illustrating an example of states of a server management table and a server group management table when a server group arranged under a first switch is registered, according to an embodiment;

FIG. 19 is a diagram illustrating an example of states of a server management table and a server group management table when server groups arranged under a second switch to a fourth switch are registered, according to an embodiment;

FIG. 20 is a diagram illustrating an example of a state of a physical path table when a first path is registered, according to an embodiment;

FIG. 21 is a diagram illustrating an example of a state of a physical path table when a second path to a fourth path are registered, according to an embodiment;

FIG. 22 is a diagram illustrating an example of a state of a physical path table when an overlapping path is removed, according to an embodiment;

FIG. 23 is a diagram illustrating a state when a failure has occurred between switches, according to an embodiment;

FIG. 24 is a diagram illustrating an example of a state when a failure has occurred between a server and a switch, according to an embodiment;

FIG. 25 is a diagram illustrating an example of effects occurring when servers are grouped, according to an embodiment; and

FIG. 26 is a diagram illustrating an example of a hardware configuration of a computer that executes an affected range identification program, according to an embodiment.

### DESCRIPTION OF EMBODIMENT

In a case where, upon a failure occurring in a cloud system, customers who are affected by the failure are identified based on physical path information and the configuration information of a virtual system, the physical path information becomes more complex and increases in size as the numbers of servers and switches increase. Therefore, there is an issue in that the time taken to perform a process of identifying customers who are affected by the failure increases.

It is preferable to decrease the amount of information for use in the identification of customers who are affected by a failure to thus reduce the time taken to perform a process of identifying customers who are affected by a failure.

Hereinafter, an embodiment of an affected range identification program and an affected range identification device disclosed herein will be described in detail with reference to the accompanying drawings. Note that this embodiment is not intended to limit the technique of the present disclosure.

### Embodiment

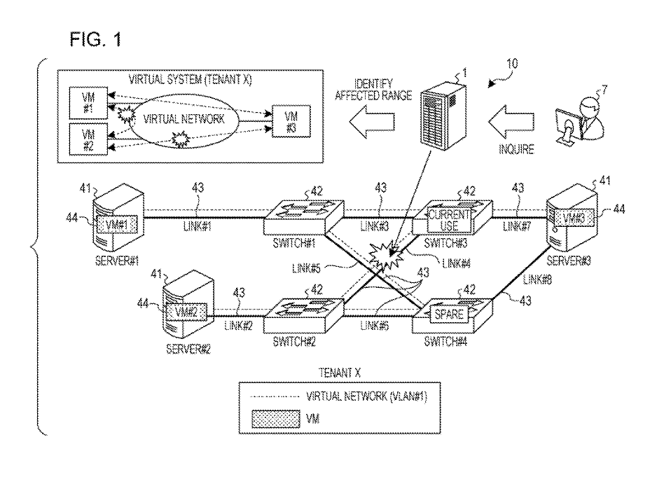

First, an information processing system according to an embodiment will be described. FIG. 1 is a diagram illustrating an information processing system according to an embodiment. As illustrated in FIG. 1, an information processing system 10 according to the embodiment includes a cloud management device 1, three servers 41, and four switches 42. The three servers 41 are denoted as server#1 to server#3, and the four switches 42 are denoted as switch#1 to switch#4. Switch#4 is a spare switch 42, and switch#3 and switch#4 have a relationship in which one is a redundant node to replace the other. Server 41 and switch 42, as well as a pair of switches 42, are coupled by a link 43. In FIG. 1, eight links 43 are denoted as link#1 to link#8, and each link 43 is represented by a solid line. For example, server#1 and switch#11 are coupled by link#1.

The server 41 is an information processing device that performs information processing. The switch 42 is a device that relays communication between the servers 41. Note that, in FIG. 1, although the information processing system 10 includes three servers 41, four switches 42, and eight links 43, the information processing system 10 may include arbitrary numbers of servers 41, switches 42, and links 43.

VM#1 operates on server#1, VM#2 on server#2, and VM#3 on server#3. Here, a VM is a virtual machine that operates on the server 41. VMs are allocated to a tenant who uses the information processing system 10. In addition, a virtual network is allocated to a tenant who uses the information processing system 10. In FIG. 1, virtual local area network (VLAN) #1 is allocated to a tenant X. The virtual network is represented by a broken line. Note that, in FIG. 1, although one VM 44 is allocated to one server 41, and one virtual network to one tenant, a plurality of VMs 44 may be allocated to one server 41, and a plurality of virtual networks to one tenant.

The cloud management device 1 is a device that, upon a failure occurring in a network, identifies customers who are affected by the failure by identifying inter-VM communication that is affected by the failure. For example, once a failure has occurred in a network infrastructure, a cloud service provider 7 who operates the cloud system makes an inquiry to the cloud management device 1 about the affected range. The cloud management device 1 identifies customers who are affected by the failure by identifying inter-VM communication that is affected by the failure, and displays the identification result on a display device used by the cloud service provider 7. In FIG. 1, once a failure has occurred in link#4, the cloud management device 1 identifies communication between VM#1 and VM#2 and communication between VM#2 and VM#3, as inter-VM communication that is affected by the failure. Then, the cloud management device 1 identifies customers who are affected by the failure, based on association information between the VMs 44 and the customers.

The cloud management device 1 manages the servers 41 each coupled to edge switches which are common to all of these servers 41, as the same server group, and manages a communication path across server groups. Here, the edge switch refers to the switch 42 coupled directly to the server 41 via one link 43. In FIG. 1, all of switch#1 to switch#4 are edge switches.

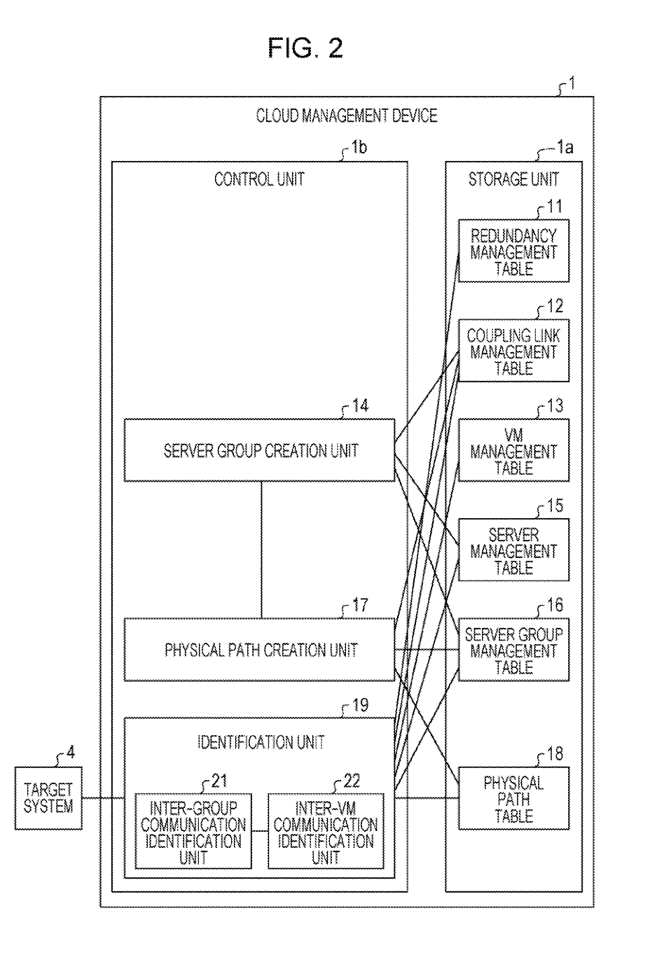

Next, the cloud management device 1 will be described. FIG. 2 is a diagram illustrating a functional configuration of the cloud management device 1. As illustrated in FIG. 2, the cloud management device 1 includes a storage unit la that stores data for use in management of server groups, data for use in analysis of the effects caused by a failure, and the like, and a control unit lb that performs control of creation of data for use in management of server groups, control of analysis of the effects caused by a failure, and the like. The storage unit la stores a redundancy management table 11, a coupling link management table 12, a VM management table 13, a server management table 15, a server group management table 16, and a physical path table 18. The control unit lb includes a server group creation unit 14, a physical path creation unit 17, and an identification unit 19.

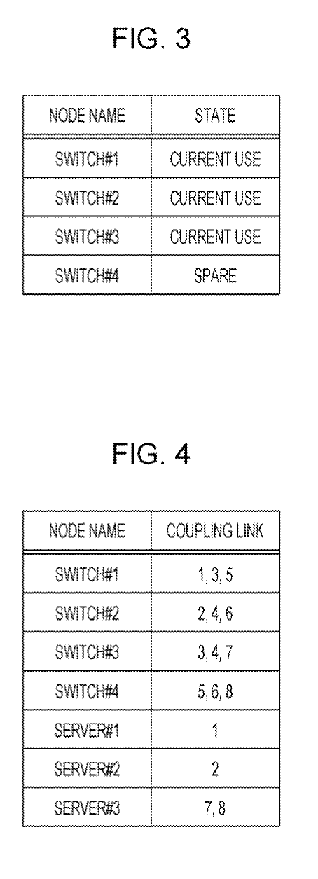

In the redundancy management table 11, information on the redundancy configuration of the information processing system 10 is registered. FIG. 3 is a diagram depicting an example of the redundancy management table 11. As depicted in FIG. 3, node names are associated with states in the redundancy management table 11. The node name is an identifier that identifies the switch 42. The state indicates the usage state of the switch 42. The switch 42 is being used when the state is “current use”, and the switch 42 is not being used when the state is “spare”. For example, switch#1 is being used, and switch#4 is not being used.

In the coupling link management table 12, information on the link 43 coupled to the switch 42 or the server 41 is registered. FIG. 4 is a diagram depicting an example of the coupling link management table 12. As depicted in FIG. 4, node names are associated with coupling links in the coupling link management table 12. The node name is an identifier that identifies the switch 42 or an identifier that identifies the server 41. The coupling link is an identification number that identifies the link 43 coupled to the switch 42 or the server 41. For example, the links 43 coupled to switch#1 include link#1, link#3, and link#5. In addition, the links 43 coupled to server#1 include link#1. Note that link#n refers to the link 43 whose identification number is n.

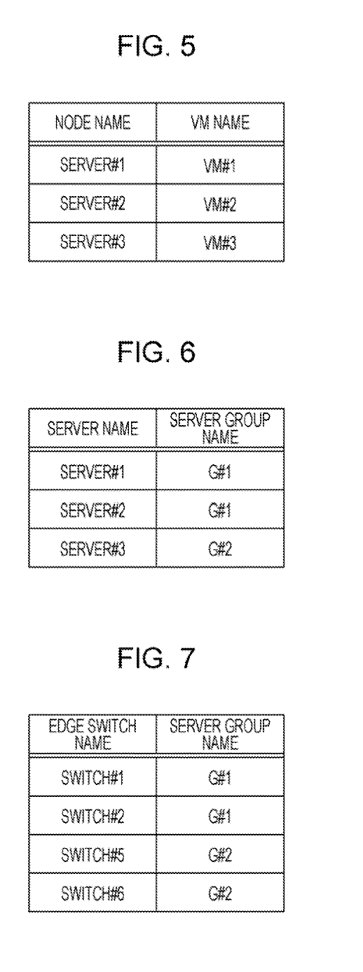

In the VM management table 13, the VM 44 that operates on the server 41 is registered. FIG. 5 is a diagram illustrating an example of the VM management table 13. As depicted in FIG. 5, node names are associated with VM names in the VM management table 13. The node name is an identifier that identifies the server 41. The VM name is an identifier that identifies the VM 44. For example, VM#1 operates on server#1, and VM#2 operates on server#2.

The server group creation unit 14 groups the servers 41 with reference to the coupling link management table 12 and creates the server management table 15 and the server group management table 16. The server group creation unit 14 groups the servers 41 each coupled to edge switches which are common to all of these servers 41, into the same group.

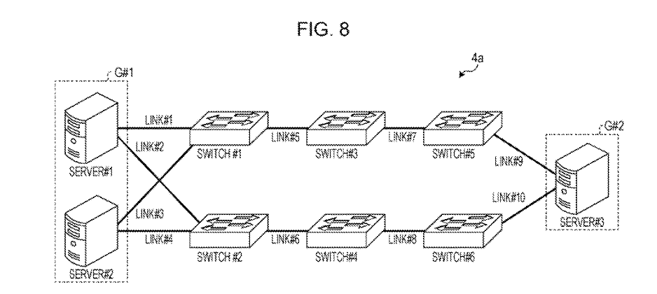

In the server management table 15, information on a server group is registered for each server. In the server group management table 16, information on edge switches to which a server group is coupled is registered. FIG. 6 is a diagram illustrating an example of the server management table 15, FIG. 7 is a diagram illustrating an example of the server group management table 16, and FIG. 8 is a diagram illustrating an example of a target system 4a used for creating the tables of FIG. 6 and FIG. 7.

As depicted in FIG. 6, server names and server group names are associated with each other in the server management table 15. The server name is an identifier that identifies the server 41. The server group name is an identifier that identifies a server group. As depicted in FIG. 7, edge switch names and server group names are associated with each other in the server group management table 16. The edge switch name is an identifier that identifies an edge switch. The server group name is an identifier that identifies a server group.

As illustrated in FIG. 8, in an information processing system 10a, server#1 and server#2 are coupled to switch#1 and switch#2, which are edge switches, and thus the edge switches to which server#1 and server#2 are coupled are common to both server#1 and server#2. Accordingly, server#1 and server#2 are included in the same group whose identifier is G#1, and thus, in FIG. 6, server#1 and server#2 are associated with G#1 and, in FIG. 7, switch#1 and switch#2 are associated with G#1.

As also illustrated in FIG. 8, in the information processing system 10a, server#3 is coupled to switch#5 and switch#6, which are edge switches, and there is no other server coupled to the same edge switches (switch#5 and switch#6). Accordingly, server#3 is included in a group whose identifier is G#2, and thus, in FIG. 6, server#3 is associated with G#2 and, in FIG. 7, switch#5 and switch#6 are associated with G#2.

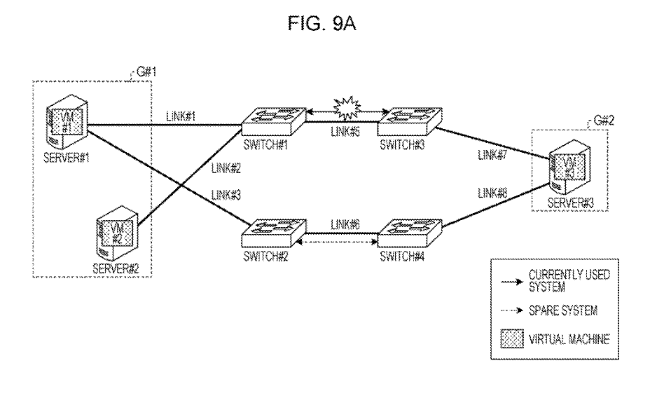

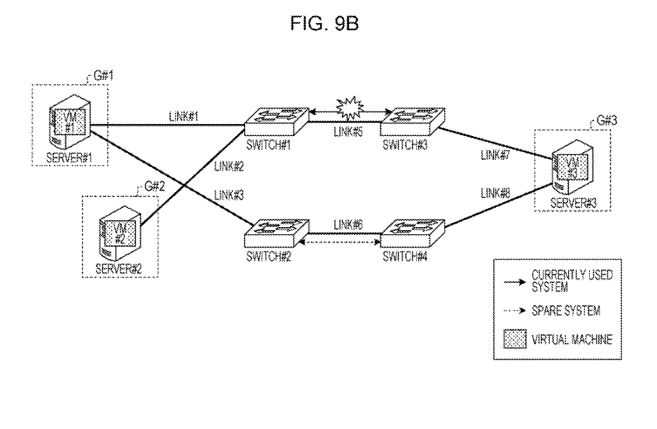

The server group creation unit 14 performs group assignment in accordance with the policy that the servers 41 each coupled to edge switches which are common to all of these servers 41 are assigned to the same group. In contrast, the policy that all of the servers 41 arranged under a switch are assigned to the same group is conceivable. FIG. 9A is a diagram illustrating a group assignment example 1 in which all of the servers 41 arranged under a switch are assigned to the same group, and FIG. 9B is a diagram illustrating a group assignment example 2 in which the servers 41 each coupled to edge switches which are common to all of these servers 41 are assigned to the same group.

As illustrated in FIG. 9A, in the group assignment example 1, server#1 and server#2 arranged under switch#1 are assigned to the same group G#1. Next, despite an attempt to assign a group to server#1 arranged under switch#2, group G#1 is already assigned to server#1 and therefore new assignment to server#1 is not performed. Next, group G#2 is assigned to server#3 arranged under switch#3. Next, despite an attempt to assign a group to server#3 arranged under switch#4, group G#2 is already assigned to server#3 and therefore new assignment to server#3 is not performed.

Further, once a failure has occurred in link#5, while server#1 has a path passing through link#6 for communication with server#3 and therefore is not affected by the failure, server#2 does not have another path for communication with server#3 and therefore is affected. That is, in the group assignment example 1, the servers 41 that differ in terms of being affected by the failure are present in the same group G#1.

In contrast, as illustrated in FIG. 9B, in the group assignment example 2, server#1 is coupled to switch#1 and switch#2, server#2 to switch#1, and server#3 to switch#3 and switch#4. That is, a set of the edge switches coupled to each of server#1 to server#3 is different among server#1 to server#3. Accordingly, different groups, group G#1 to group G#3, are assigned to server#1 to server#3, respectively.

Further, once a failure has occurred in link#5, while server#1 has a path passing through link#6 for communication with server#3 and therefore is not affected by the failure, server#2 does not have another path for communication with server#3 and therefore is affected. However, since different groups are assigned to server#1 and server#2, the servers 41 that differ in terms of being affected by the failure are absent in the same group. In such a way, the server group creation unit 14 assigns servers 41 each coupled to edge switches which are common to all of the servers 41, to the same group, thereby enabling all of the servers 41 in the same group to have the same effects of the failure.

The server group creation unit 14 creates a server group by performing the following steps (1) to (5).

(1) Select one edge switch.

(2) Extract a server 41 that is adjacent to the edge switch selected in (1) and to which a server group is not assigned, assign a server group to the server 41, and extract all of edge switches to which the extracted server 41 is coupled.

(3) Extract another server 41 that is adjacent to the edge switch selected in (1) and to which a server group is not assigned, and extract all of edge switches to which the other extracted server 41 is coupled.

(4) Compare the edge switches extracted in (2) with the edge switches extracted in (3), and assign the server group assigned in (2) to the other server 41 when all of the edge switches extracted in (2) are the same as the edge switches extracted in (3).

(5) Repeat the steps (3) and (4) until no other server 41 adjacent to the selected edge switch is left, and repeat the steps (1) to (4) until no edge switch is left.

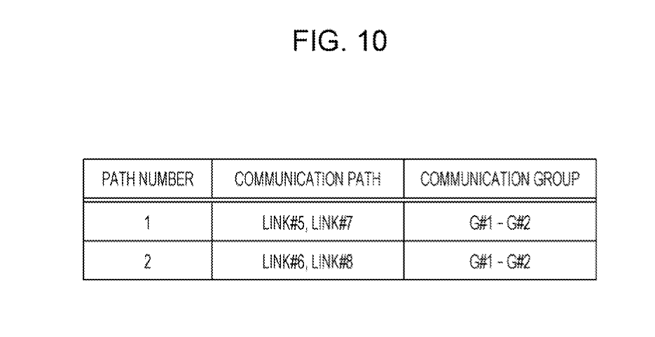

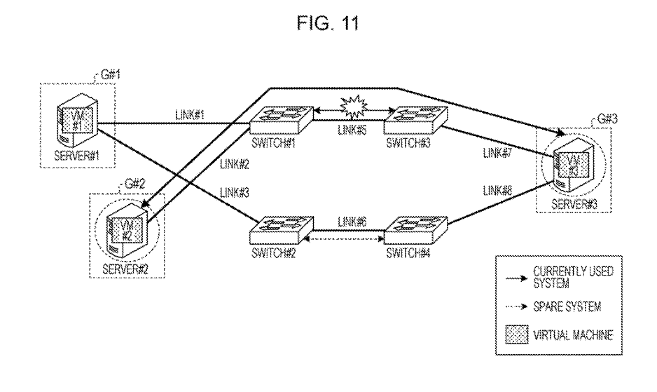

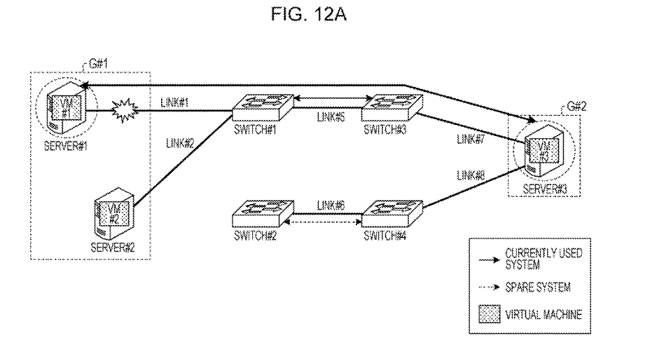

The physical path creation unit 17 identifies a sequence of the links 43 that together couple a pair of edge switches, with reference to the coupling link management table 12 and the server group management table 16, and creates the physical path table 18. In the physical path table 18, a physical path and two server groups that perform communication by using the physical path are registered. FIG. 10 is a diagram illustrating an example of the physical path table 18. FIG. 10 depicts the physical path table 18 created for the information processing system 10a illustrated in FIG. 8.

As depicted in FIG. 10, path numbers, communication paths, and communication groups are associated with one another in the physical path table 18. The path number refers to an identification number that identifies a physical path. The communication path refers to a set of identifiers of the links 43 included in a physical path. The communication group refers to the identifiers of two server groups that communicate using the physical path. For example, the physical path with a path number “1” includes “link#5” and “link#7” and is used for communication between “G#1” and “G#2”.

The physical path creation unit 17 identifies all of the physical paths by searching for a path from an edge switch to another edge switch for each of the edge switches. Further, with reference to the server group management table 16, the physical path creation unit 17 extracts server groups arranged under edge switches at both ends of the physical path and creates a combination of server groups, and registers the combination in association with the physical path in the physical path table 18.

The identification unit 19 identifies an inter-VM communication that is affected by a failure that has occurred. The identification unit 19 includes an inter-group communication identification unit 21 and an inter-VM communication identification unit 22.

The inter-group communication identification unit 21 identifies inter-server group communication affected by a failure that has occurred. That is, the inter-group communication identification unit 21 identifies a physical path affected by a failure that has occurred, with reference to the physical path table 18, and determines whether the identified physical path is currently being used, with reference to the redundancy management table 11 and the coupling link table 12. Further, when the identified physical path is currently being used, the inter-group communication identification unit 21 identifies the corresponding inter-server group communication with reference to the physical path table 18, and determines whether there is another physical path for the identified inter-server group communication. Further, the inter-group communication identification unit 21 identifies an inter-server group communication without another physical path out of identified inter-server group communication, as an inter-server communication affected by the failure that has occurred.

The inter-VM communication identification unit 22 identifies inter-server communication affected by the failure, from the inter-server group communication identified by the inter-group communication identification unit 21, and identifies inter-VM communication affected by the failure, from the identified inter-server communication. That is, the inter-VM communication identification unit 22 extracts the servers 41 in the two server groups involved in the inter-server group communication identified by the inter-group communication identification unit 21, respectively, with reference to the server management table 15. Further, the inter-VM communication identification unit 22 creates a combination of the servers 41 from among different server groups, and, with reference to the VM management table 13, identifies an inter-VM communication affected by the failure that has occurred.

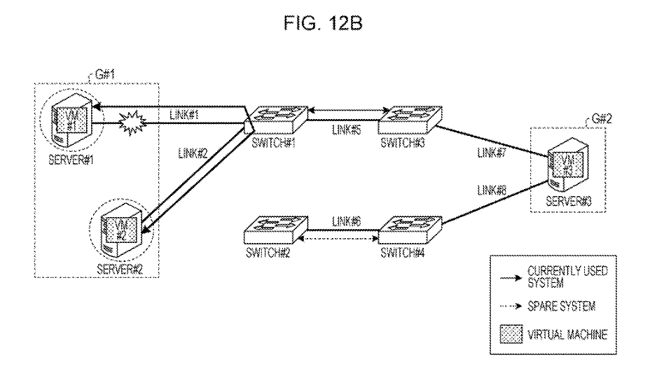

In such a way, considering whether a physical path affected by a failure that has occurred is currently being used, and, when the physical path is currently being used, considering whether there is a redundant path for inter-server group communication or inter-server communication that is affected by the failure, the identification unit 19 identifies inter-VM communication affected by the failure. FIG. 11 is a diagram illustrating an example of identification of an affected range in consideration of a redundant path. As illustrated in FIG. 11, in the case of a failure occurring in link#5, since the physical path including link#5 is the currently used system, communication between server group G#1 and server group G#3 and communication between server group G#2 and server group G#3 are extracted as inter-server group communication that may be affected by the failure.

A spare path passing through link#6 is provided for communication between server group G#1 and server group G#3, and therefore this communication is not affected by the failure. In contrast, a spare path is not provided for communication between server group G#2 and server group G#3. Therefore, communication between server#2 and server#3 is affected by the failure, and communication between VM#2 and VM#3 is identified as inter-VM communication affected by the failure.

In addition, once a failure has occurred in a physical path between the server 41 and an edge switch, the inter-group communication identification unit 21 identifies a physical path passing through an edge switch coupled to the failure location with reference to the coupling link table 12 and the physical path table 18. Further, the inter-group communication identification unit 21 determines whether the identified physical path is currently being used, with reference to the redundant management table 11 and the coupling link table 12. When the identified path is currently being used, the inter-group communication identification unit 21 identifies inter-server group communication that uses the identified physical path. In the case, inter-server group communication to be identified is communication involving a server group to which the server 41 coupled to a failure location belongs.

Further, the inter-group communication identification unit 21 determines whether another physical path is provided for the identified inter-server group communication, with reference to the physical path table 18. The inter-group communication identification unit 21 identifies inter-server group communication without another physical path out of the identified inter-server group communication, as inter-server group communication affected by a failure that has occurred.

Further, the inter-VM communication identification unit 22 extracts the respective servers 41 in two server groups involved in the inter-server group communication identified by the inter-group communication identification unit 21, with reference to the server management table 15. Here, the inter-VM communication identification unit 22 extracts only the servers 41 coupled to a failure location from a server group to which the servers 41 coupled to the failure location belong. Further, the inter-VM communication identification unit 22 creates combinations of the servers 41 among server groups, and identifies inter-VM communication affected by a failure that has occurred with reference to the VM management table 13.

FIG. 12A is a first diagram illustrating an example of identification of an affected range when a failure has occurred in a path between the server 41 and an edge switch. As illustrated in FIG. 12A, when a failure has occurred in link#1, communication between server group G#1 and server group G#2 is identified as the currently used inter-server group communication. Further, since there is not another path between server group G#1 and server group G#2, server#1 coupled to link#1 in which the failure has occurred is extracted from server group G#1, and server#3 is extracted from server group G#2. Further, inter-VM communication between VM#1 formed of server#1 and VM#3 formed of server#3 is identified as inter-VM communication affected by a failure.

In addition, when a failure has occurred in a path between the server 41 and an edge switch, the inter-VM communication identification unit 22 extracts the physical path of inter-server communication affected by the failure, in the server group to which the server 41 coupled to the failure location belongs. Further, the inter-VM communication identification unit 22 determines whether the extracted physical path is currently being used, with reference to the redundancy management table 11 and the coupling link table 12. Further, when the extracted physical path is currently being used, the inter-VM communication identification unit 22 determines whether there is another path, with reference to the redundancy management table 11 and the coupling link table 12. When there is no other path, the inter-VM communication identification unit 22 extracts the VM 44 formed of the server 41 involved in the affected inter-server communication and identifies a combination of VMs on the different servers as inter-VM communication affected by the failure.

FIG. 12B is a second diagram illustrating an example of identification of an affected range when a failure has occurred in a path between the server 41 and an edge switch. As illustrated in FIG. 12B, when a failure has occurred in link#1, communication between server#1 and server#2 is extracted as inter-server communication affected by the failure. Further, communication between server#1 and server#2 is currently being used, and there is not another path. Therefore, VM#1 formed of server#1 and VM#2 formed of server#2 are extracted. Further, communication between VM#1 and VM#2 is identified as inter-VM communication affected by the failure.

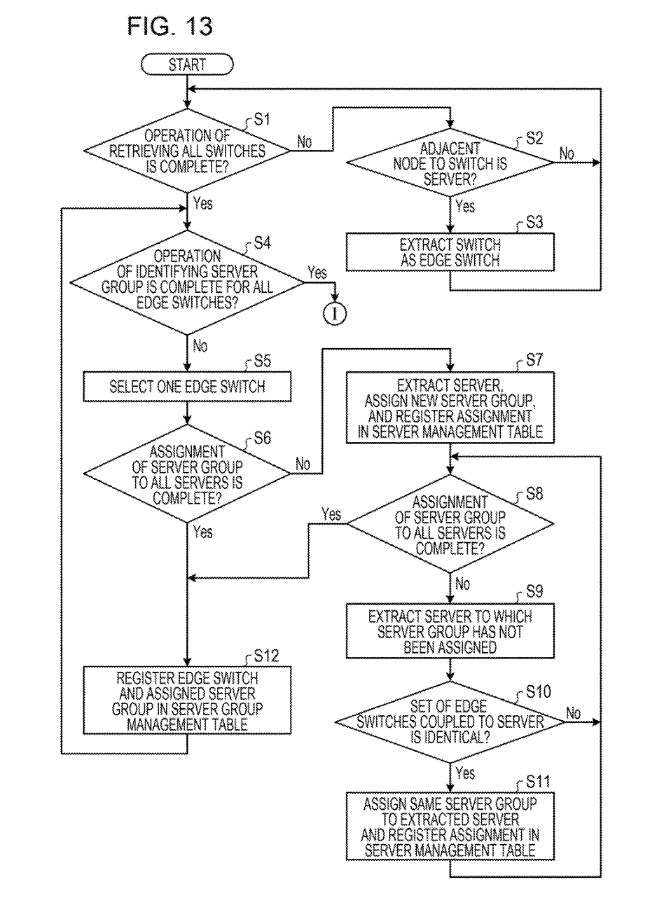

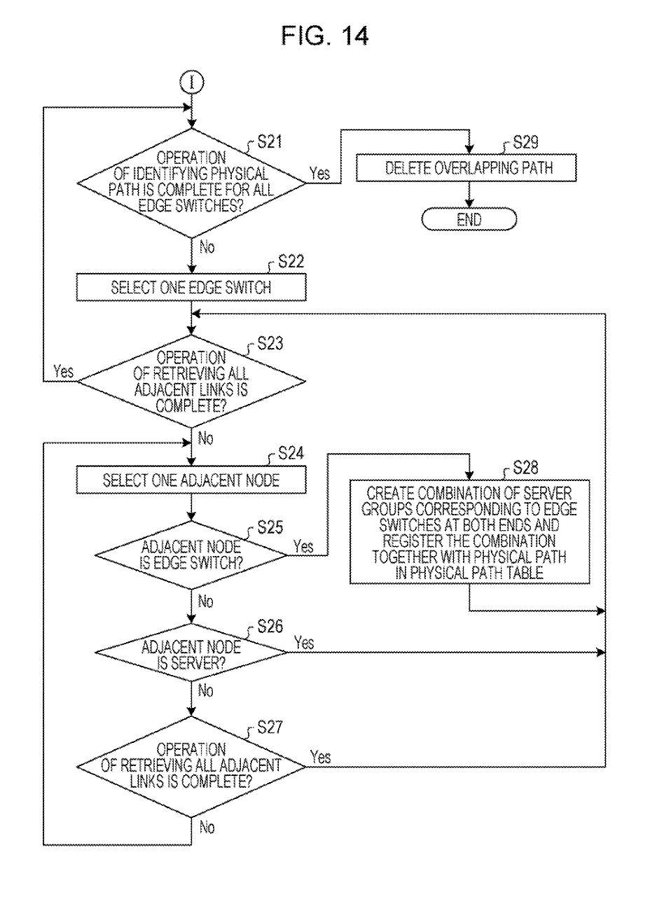

Next, the flow of a process of creating a server group and creating the physical path table 18 will be described. FIG. 13 is a flowchart illustrating a flow of a process of creating a server group, and FIG. 14 is a flowchart illustrating a flow of a process of creating the physical path table 18. Note that creation of a server group is performed after an information processing system is constructed, and is also performed when a change has been made to the network configuration and when a change has been made to the server configuration.

As illustrated in FIG. 13, the server group creation unit 14 determines whether an operation of retrieving all of the switches 42 from the coupling link management table 12 is complete (S1). Then, when the switch 42 that has not been retrieved is present, the server group creation unit 14 retrieves one switch 42 and determines whether a node adjacent to the retrieved switch 42 is the server 41 (S2). Then, when the adjacent node is not the server 41, the server group creation unit 14 returns to S1, whereas when the adjacent node is the server 41, the server group creation unit 14 extracts the retrieved switch 42 as an edge switch (S3) and returns to S1.

On the other hand, when the operation of retrieving all of the switches 42 is complete, the server group creation unit 14 determines whether an operation of identifying a server group is complete for all of the edge switches (S4). As a result, when an edge switch for which the operation of identifying a server group has not been performed is present, the server group creation unit 14 selects one edge switch (S5). Then, the server group creation unit 14 determines whether assignment of a server group to all of the servers arranged under the selected edge switch is complete (S6).

When the server 41 to which server group assignment has not been performed is present, the server group creation unit 14 extracts the server 41 to which a server group has not been assigned, assigns a new server group, and registers the assignment in the server management table 15 (S7). Further, the server group creation unit 14 determines whether server group assignment to all of the servers arranged under the selected edge switch is complete (S8).

When the server 41 to which server group assignment has not been performed is present, the server group creation unit 14 extracts the server 41 to which a server group has not been assigned (S9). Further, the server group creation unit 14 determines whether the extracted server and the server 41 to which the server group has been assigned in S7 are each coupled to the identical set of edge switches (S10). When the determination result is that the two servers are each coupled to the identical set of edge switches, the server group creation unit 14 assigns the same server group as assigned in S7 to the extracted server 41 and registers the assignment in the server management table 15 (S11) and returns to S8. When the servers are not coupled to the identical set of edge switches, the server group creation unit 14 returns to step S8.

When, in S8, the server group assignment to all of the servers is complete, the server group creation unit 14 registers the selected edge switch and the assigned server group in the server group management table 16 (S12). In addition, when, in S6, the server group assignment to all of the servers is complete, the server group creation unit 14 registers the selected edge switch and the assigned server group in the management table 16 (S12). Then, the server group creation unit 14 returns to S4.

When, in S4, the operation of identifying a server group is complete for all of the edge switches, the server group creation unit 14 terminates the process and the physical path creation unit 17 starts the process of creating the physical path table 18.

As illustrated in FIG. 14, the physical path creation unit 17 determines whether an operation of identifying a physical path is complete for all of the edge switches (S21). As a result, when an edge switch for which the operation of identifying a physical path has not been performed is present, the physical path creation unit 17 selects one edge switch (S22). Further, the physical path creation unit 17 determines whether an operation of retrieving all adjacent links to the selected edge switch is complete (S23), and, when an adjacent link that has not been retrieved is present, selects one adjacent node (S24).

Further, the physical path creation unit 17 determines whether the selected adjacent node is an edge switch (S25), and, when not, determines whether the adjacent node is the server 41 (S26). As a result, when the adjacent node is not the server 41, the physical path creation unit 17 determines whether the operation of retrieving all adjacent links for the adjacent node is complete (S27), and, when an adjacent link that has not been retrieved is present, returns to S24.

On the other hand, when the operation of retrieving all adjacent links for the adjacent node is complete, or when the adjacent node is the server 41, the physical path creation unit 17 returns to S23. In addition, when, in S25, the adjacent node is an edge switch, the physical path creation unit 17 creates a combination of server groups corresponding to edge switches at both ends of the retrieved physical path and registers the combination, together with the physical path, in the physical path table 18 (S28). The physical path creation unit 17 then returns to S23.

In addition, when, in S23, the operation of retrieving all adjacent links is complete, the physical path creation unit 17 returns to S21. When, in S21, the operation of identifying a physical path for all edge switches is complete, the physical path creation unit 17 deletes an overlapping path from the physical path table 18 (S29) and terminates the process of creating the physical path table 18.

In such a way, the server group creation unit 14 creates server groups, and the physical path creation unit 17 creates the physical path table 18 based on the server groups. This enables the identification unit 19 to identify the affected range of a failure with reference to the physical path table 18.

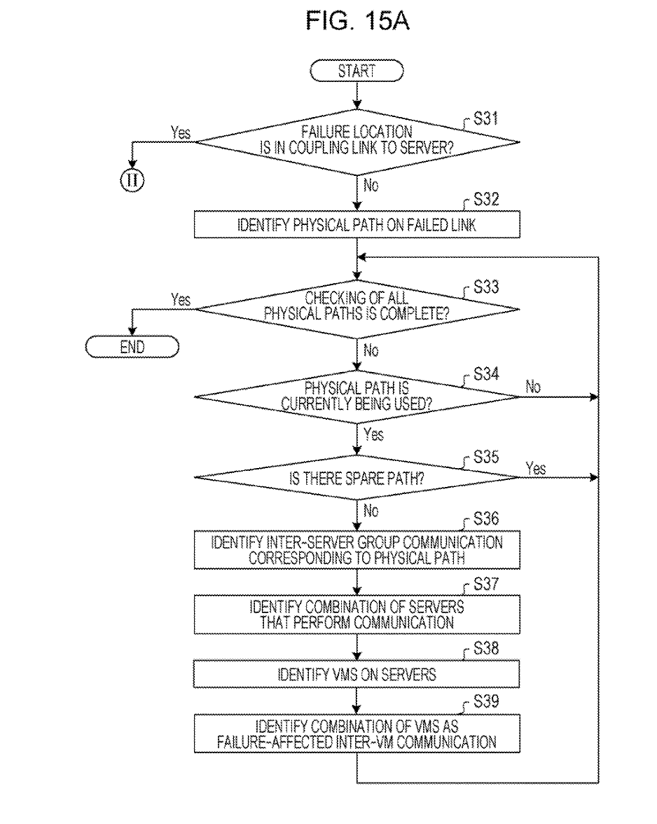

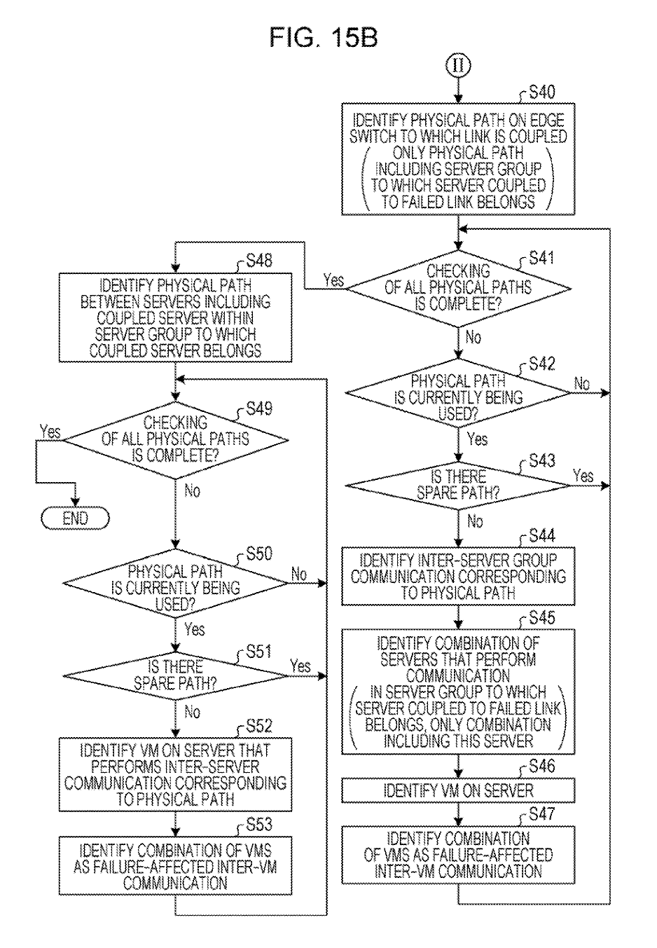

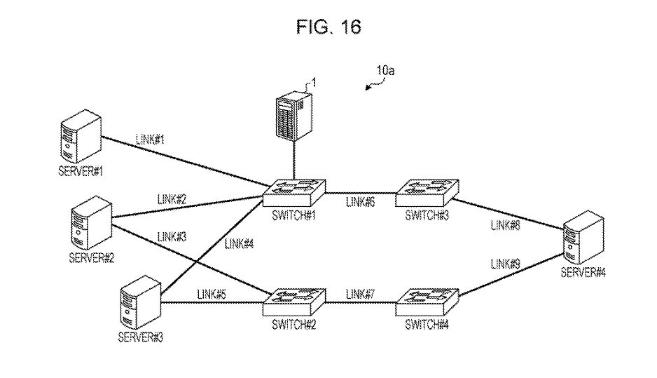

Next, the flow of a process of identifying an affected range will be described. FIG. 15A is a first flowchart illustrating a flow of a process of identifying an affected range, and FIG. 15B is a second flowchart illustrating a flow of the process of identifying an affected range. Note that the process of identifying an affected range is started when the identification unit 19 receives a failure occurrence notification.

As illustrated in FIG. 15A, the identification unit 19 determines whether the failure location is in a coupling link to the server 41 (S31), and, when the failure location is not in the coupling link to the server 41, identifies a physical path on a failed link (S32). Further, the identification unit 19 determines whether checking of all of the physical paths is complete (S33), and, when checking is complete, terminates the process.

On the other hand, when a physical path that has not been checked is present, the identification unit 19 determines for one of the identified physical paths whether this physical path is currently being used (S34), and, when the physical path is not currently being used, returns to S33. On the other hand, when the physical path is currently being used, the identification unit 19 determines whether there is a spare path (S35), and, when there is a spare path, returns to S33.

On the other hand, when there is no spare path, the identification unit 19 identifies inter-server group communication corresponding to the physical path (S36), and identifies a combination of the servers 41 that perform communication, based on the identified inter-server group communication (S37). Further, the identification unit 19 identifies the VMs 44 on the identified servers (S38) and identifies the identified combination of the VMs 44 as inter-VM communication affected by the failure (S39). Then, the identification unit 19 returns to S33.

In addition, when, in S31, the failure location is in a coupling link to the server 41, as illustrated in FIG. 15B, the identification unit 19 identifies a physical path on an edge switch to which the link 43 is coupled (S40). Here, the identification unit 19 identifies only a physical path including a server group to which the server 41 coupled to the failed link belongs.

Further, the identification unit 19 determines whether checking of all of the physical paths is complete (S41), and, when a physical path that has not been checked is present, the identification unit 19 determines for one of the identified physical paths whether this physical path is currently being used (S42). When the physical path is not currently being used, the identification unit 19 returns to S41. On the other hand, when the physical path is currently being used, the identification unit 19 determines whether there is a spare path (S43), and, when there is a spare path, returns to S41.

On the other hand, when there is no spare path, the identification unit 19 identifies inter-server group communication corresponding to the physical path (S44), and identifies a combination of the servers 41 that perform communication, based on the identified inter-server group communication (S45). Here, for a server group to which the server 41 coupled to the failed link belongs, the identification unit 19 identifies only a combination including the server 41 coupled to the failed link. Further, the identification unit 19 identifies the VM 44 on the identified server (S46) and identifies a combination of the identified VMs 44 as inter-VM communication affected by the failure (S47).

In addition, in S41, when checking of all of the physical paths is complete, the identification unit 19 identifies a physical path between servers including a coupled server, which is coupled to the failed link, within a server group including the coupled server (S48). Further, the identification unit 19 determines whether checking of all of the physical paths is complete (S49), and, when checking of all of the physical paths is complete, terminates the process.

On the other hand, when a physical path that has not been checked is present, the identification unit 19 determines for one of the identified physical paths, this physical path is currently being used (S50), and, when the physical path is not currently being used, returns to S49. On the other hand, when the physical path is currently being used, the identification unit 19 determines whether there is a spare path (S51), and, when there is a spare path, returns to S49.

On the other hand, when there is no spare path, the identification unit 19 identifies the VM 44 on a server that performs inter-server communication corresponding to the physical path (S52) and identifies a combination of the identified VMs 44 as inter-VM communication affected by the failure (S53).

In such a way, the identification unit 19 identifies the inter-server group communication affected by the failure, identifies, based on the identified inter-server group communication, the inter-server communication affected by the failure, and identifies, based on the identified inter-server communication, the inter-VM communication affected by the failure. Accordingly, the identification unit 19 may reduce the time taken for identifying the inter-VM communication affected by the failure.

Next, an example of identification of an affected range will be described with reference to FIG. 16 to FIG. 25. FIG. 16 is a diagram illustrating an information processing system 10a for use in explanation of an example of identification of an affected range. As illustrated in FIG. 16, the information processing system 10a includes the cloud management device 1, four servers, server#1 to server#4, and four switches, switch#1 to switch#4. Switch#2 and switch#4 are spares.

Server #1 is coupled to switch#1 via link#1. Server#2 is coupled to switch#1 via link#2 and is coupled to switch#2 via link#3. Server#3 is coupled to switch#1 via link#4 and is coupled to switch#2 via link#5. Switch#1 and switch#3 are coupled via link#6. Switch#2 and switch#4 are coupled via link#7. Server#4 is coupled to switch#3 via link#8 and is coupled to switch#4 via link#9.

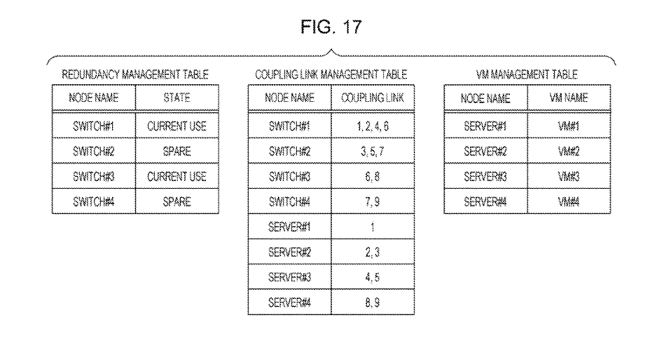

FIG. 17 is a diagram illustrating the redundancy management table 11, the coupling link management table 12, and the VM management table 13 corresponding to the information processing system 10a illustrated in FIG. 16. As illustrated in FIG. 17, switch#1 and switch#3 are registered as “current use” and switch#2 and switch#4 are registered as “spare” in the redundancy management table 11.

Switch#1 being coupled to link#1, link#2, link#4, and link#6 and switch#2 being coupled to link#3, link#5, and link#7 are registered in the coupling link management table 12. Switch#3 being coupled to link#6 and link#8 and switch#4 being coupled to link#7 and link#9 are registered in the coupling link management table 12. Server#1 being coupled to link#1, server#2 being coupled to link#2 and link#3, server#3 being coupled to link#4 and link#5, and server#4 being coupled to link#8 and link#9 are registered in the coupling link management table 12.

VM#1 operating on server#1, VM#2 operating on server#2, VM#3 operating on server#3, and VM#4 operating on server#4 are registered in the VM management table 13.

The physical path creation unit 17 first creates the server management table 15 and the server group management table 16. That is, based on the coupling link management table 12, the physical path creation unit 17 extracts server#1, server#2, and server#3 as the servers 41 arranged under switch#1. Further, the physical path creation unit 17 assigns server group G#1 to server#1 and assigns server group G#2 to server#2 and server#3. Further, the physical path creation unit 17 registers the server groups assigned to the servers arranged under switch#1 in the server management table 15 and the server group management table 16.

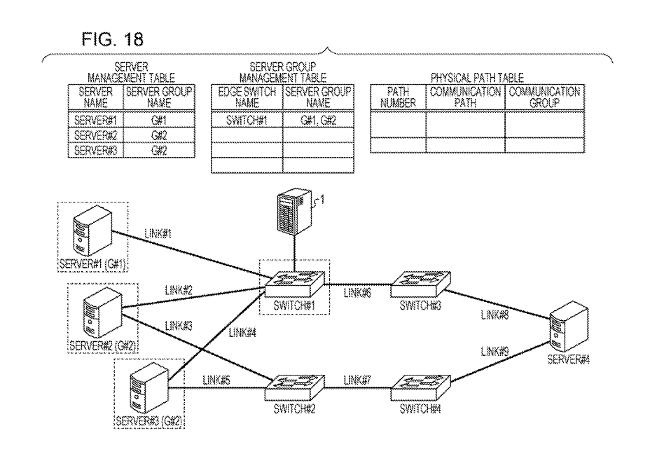

FIG. 18 is a diagram illustrating states of the server management table 15 and the server group management table 16 when server groups arranged under switch#1 are registered. As illustrated in FIG. 18, server group G#1 associated with server#1, and server#2 and server#3 associated with server group G#2 are registered in the server management table 15. Switch#1 is registered in association with server groups G#1 and G#2 in the server group management table 16.

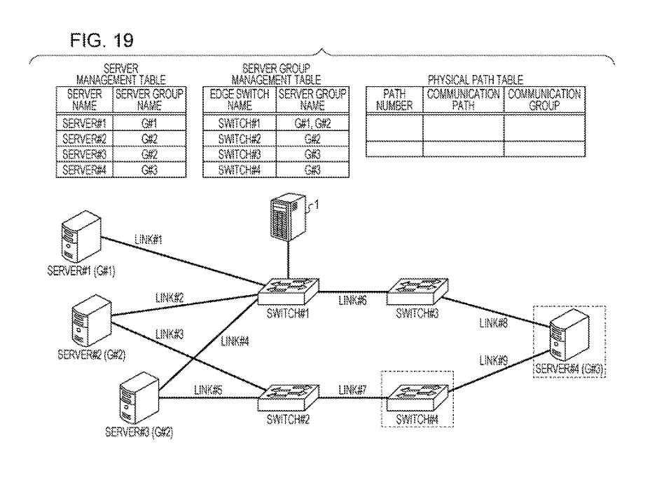

The physical path creation unit 17 performs similar operations for switch#2, switch#3, and switch#4 to assign server group G#3 to server#4. FIG. 19 is a diagram illustrating states of the server management table 15 and the server group management table 16 when server groups arranged under switch#2 to switch#4 are registered. As illustrated in FIG. 19, server#4 is registered in association with server group G#3 in the server management table 15. Switch#2 associated with server group G#2, and switch#3 and switch#4 associated with server group G#3 are registered in the server group management table 16.

Next, the physical path creation unit 17 creates the physical path table 18. That is, based on the coupling link management table 12, the physical path creation unit 17 extracts server#1, server#2, server#3, and switch#3 as adjacent nodes to switch#1. Among them, only a physical path from switch#1 to switch#3 is a physical path from an edge switch to an edge switch, and therefore the physical path creation unit 17 registers link#6 from switch#1 to switch#3 as the communication path of path#1 in the physical path table 18. Further, with reference to the server group management table 16, the physical path creation unit 17 identifies server groups G#1 and G#2 as server groups associated with switch#1, and identifies server group G#3 as a server group associated with switch#3. Further, the physical path creation unit 17 registers server groups G#1-G#3 and G#2-G#3 as communication groups corresponding to path#1 in the physical path table 18.

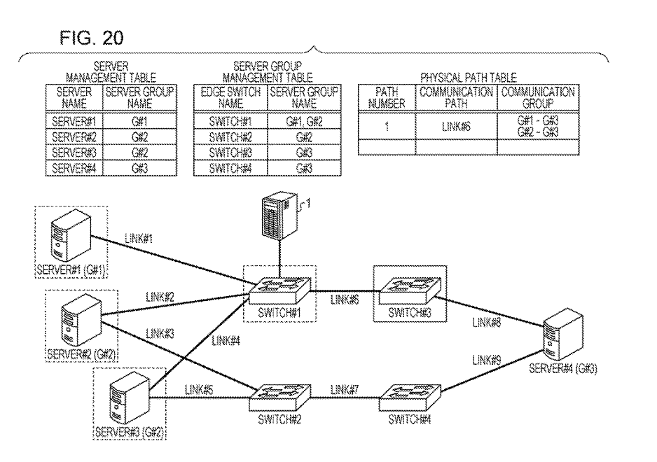

FIG. 20 is a diagram illustrating states of the physical path table 18 when path#1 is registered. As illustrated in FIG. 20, inter-server group communication “G#1-G#3” and “G#2-G#3” is associated with a physical path “link#6” with a path number “1”.

The physical path creation unit 17 performs similar operations for switch#2, switch#3, and switch#4, and registers path#2 that uses link#7 as the physical path, path#3 that uses link#6 as the physical path, and path#4 that uses link#7 as the physical path in the physical path table 18, respectively.

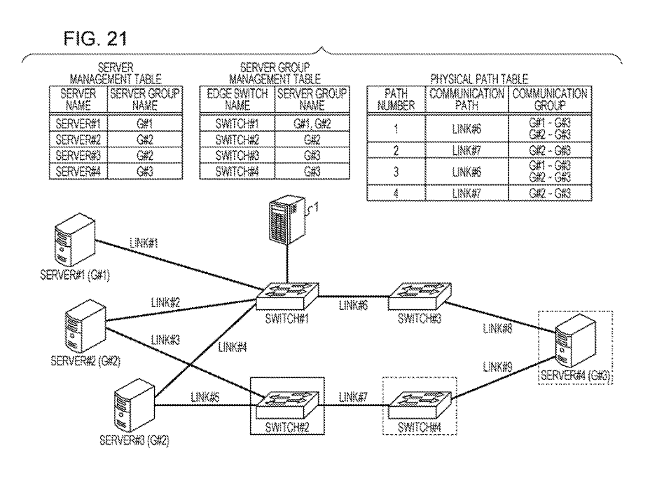

FIG. 21 is a diagram illustrating states of the physical path table 18 when path#2 to path#4 are registered. As illustrated in FIG. 21, inter-server group communication “G#2-G#3” is associated with a physical path “link#7” of a path number “2”, and inter-server group communication “G#1-G#3” and “G#2-G#3” are associated with the physical path “link#6” of a path number “3”. In addition, the inter-server group communication “G#2-G#3” is associated with the physical path “link#7” of a path number “4”.

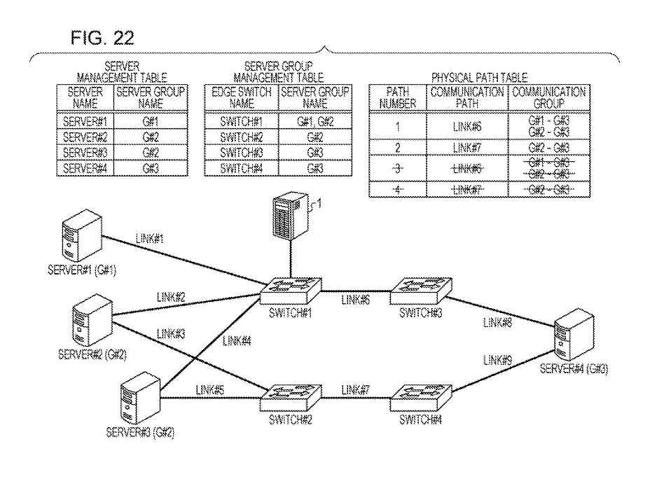

Next, the physical path creation unit 17 deletes an overlapping physical path from the physical path table 18. In FIG. 21, the communication paths of path#1 and path#3 are equal and therefore path#3 is deleted, and the communication paths of path#2 and path#4 are equal and therefore path#4 is deleted. FIG. 22 is a diagram illustrating a state of the physical path table 18 when an overlapping path is deleted. As illustrated in FIG. 22, path#3 and path#4 are deleted from the physical path table 18 illustrated in FIG. 21.

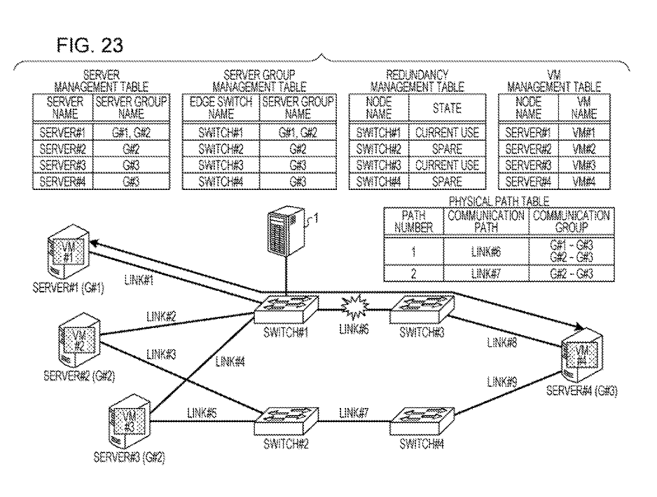

When a failure has occurred, the identification unit 19 identifies inter-VM communication affected by the failure. FIG. 23 is a diagram illustrating states when a failure has occurred between switches. In FIG. 23, a failure has occurred in link#6. As illustrated in FIG. 23, at the time of failure occurrence, VM#1 operates on server#1, VM#2 operates on server#2, VM#3 operates on server#3, and VM#4 operates on server#4. In addition, FIG. 23 illustrates the states of the server management table 15, the server group management table 16, the redundancy management table 11, the VM management table 13, and the physical path table 18 at the time of failure occurrence.

When a failure has occurred in link#6, the identification unit 19 extracts path#1 passing through link#6 with reference to the physical path table 18. Further, with reference to the redundancy management table 11, the identification unit 19 determines that path#1 is currently being used since switch#1 and switch#3 are currently being used. Further, with reference to the physical path table 18, the identification unit 19 extracts G#1-G#3 and G#2-G#3 as the inter-server group communication affected by the failure. Further, with reference to the physical path table 18, the identification unit 19 checks whether there is a spare path for the failure-affected inter-server group communication. Since path#2 is provided for G#2-G#3, the identification unit 19 determines that there is a spare path.

Accordingly, with reference to the server management table 15 for G#1 to G#3, the identification unit 19 extracts communication between server#1 and server#4 as the inter-server communication affected by the failure. Further, with reference to the VM management table 13, the identification unit 19 extracts communication between VM#1 and VM#4 as the inter-VM communication affected by the failure.

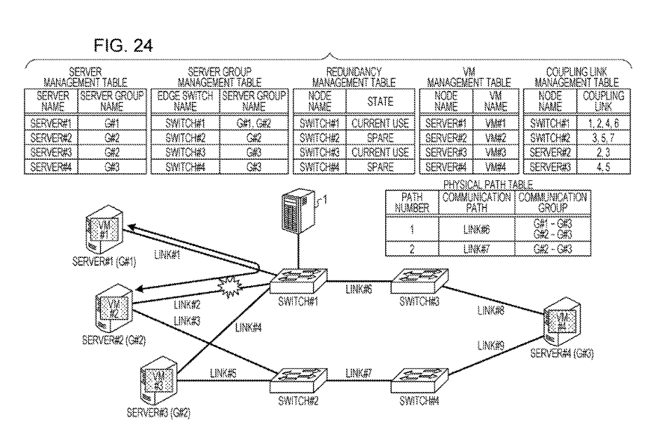

FIG. 24 is a diagram illustrating states when a failure has occurred between the server 41 and the switch 42. FIG. 24 illustrates the case where a failure has occurred in link#2. In addition, FIG. 24 illustrates the states of the server management table 15, the server group management table 16, the redundancy management table 11, the VM management table 13, the coupling link management table 12, and the physical path table 18 at the time of failure occurrence.

With reference to the coupling link management table 12 and the physical path table 18, the identification unit 19 extracts path#1 passing through switch#1 to which link#2 is coupled, as a physical path affected by the failure. Further, with reference to the redundancy management table 11, the identification unit 19 determines that path#1 is currently being used, since switch#1 and switch#3 are currently being used. Further, with reference to the physical path table 18, the identification unit 19 extracts G#2-G#3 as the inter-server group communication affected by the failure. Note that the identification unit 19 extracts only a path including server group G#2 to which server#2, to which link#2 is coupled, belongs and thus does not extract G#1-G#3. Further, with reference to the physical path table 18, the identification unit 19 determines for G#2-G#3 that path#2 is provided as a spare path. Accordingly, the identification unit 19 determines for path#1 that there is no inter-server group communication affected by the failure occurring in link#2.

In addition, with reference to the server group management table 16, the identification unit 19 creates a physical path of G#1-G#2 between server groups coupled to switch#1. Further, with reference to the redundancy management table 11, the identification unit 19 determines that G#1-G#2 is currently being used, since switch#1 is currently being used. Further, with reference to the server group management table 16, the identification unit 19 determines that there is no spare path for G#1-G#2, since there is no switch 42 coupled to server groups G#1 and G#2 other than switch#1. With reference to the server management table 15 for G#1-G#2, the identification unit 19 extracts communication between server#1 and server#2 as inter-server communication affected by the failure. Note that, regarding server group #G2, the identification unit 19 takes only server#2 coupled to link 2 into consideration and therefore does not extract communication between server#1 and server#3. Further, with reference to the VM management table 13, the identification unit 19 extracts communication between VM#1 and VM#2 as inter-VM communication affected by the failure.

In addition, with reference to the server management table 15, the identification unit 19 identifies communication between server#2 and server#3 as inter-server communication in group G#2 to which server#2 coupled to link#2 belongs. Further, with reference to the redundant management table 13, the identification unit 19 determines that the physical path of the communication between server#2 and server#3 is currently being used, since switch#1 is currently being used. Further, with reference to the coupling link management table 12, the identification unit 19 determines that there is a spare path for the communication between server#2 and server#3. Accordingly, the identification unit 19 determines that there is no failure-affected inter-server communication within a server group including the server 41 coupled to the link 43 where the failure has occurred.

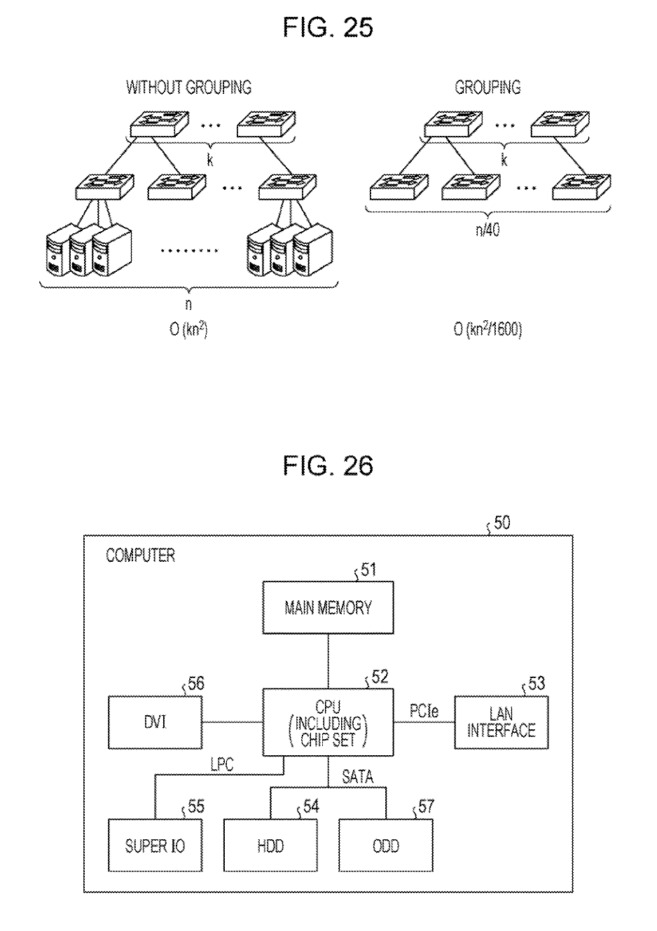

Next, advantageous effects of the case where the servers 41 are grouped will be described. FIG. 25 is a diagram for explaining advantageous effects occurring when the servers 41 are grouped. FIG. 25 indicates the complexities taken to create a path table when grouping is used and when grouping is not used, for the case where n servers 41 are coupled by the switches 41 at two levels with the number of redundant paths, k, and 40 servers 41 are coupled to edge switches.

As illustrated in FIG. 25, when grouping is not used, since the number of combinations between servers is ₙC₂=n×(n−1)/2 and the number of redundant paths is k, the computational complexity is O(kn²). Here, O(x) refers to the order x, that is, the roughly estimated value is x. On the other hand, when grouping is used, since the number of edge switches is n/40, the number of combinations between edge switches is _{n/40}C₂=n/40×(n/40−1)/2, and the number of redundant paths is k, the computational complexity is O(kn²/1600). That is, the computational complexity is reduced to approximately 1/1600 through grouping.

As described above, in the embodiment, with reference to the physical path table 18 in which a physical path is associated with two server groups that perform communication using the physical path, the inter-group communication identification unit 21 identifies inter-server group communication affected by the failure. Further, based on the inter-server group communication identified by the inter-group communication identification unit 21, the inter-VM communication identification unit 22 identifies inter-server communication affected by the failure, with reference to the server management table 15 in which the servers 41 are associated with server groups. Further, the inter-VM communication identification unit 22 identifies inter-VM communication affected by the failure with reference to the VM management table 13. Accordingly, the cloud management device 1 may identify inter-VM communication affected by the failure for a short time to reduce the time taken for identifying a customer who is affected by the failure.

In addition, in the embodiment, the inter-group communication identification unit 21 checks whether there is a spare path for the identified inter-server group communication, with reference to the physical path table 18, and, when there is a spare path, determines that the inter-server group communication is not affected by the failure. Accordingly, the cloud management unit 1 may accurately identify a customer who is affected by the failure.

In addition, in the embodiment, when a failure has occurred in the link 43 between the server 41 and an edge switch, the inter-VM communication identification unit 22 identifies only inter-server communication including a coupled server, which a server coupled to the failed link, as inter-server communication affected by the failure. Accordingly, the cloud management device 1 may accurately identify inter-server communication affected by the failure.

In addition, in the embodiment, when a failure has occurred in the link 43 between the server 41 and an edge switch, the inter-VM communication identification unit 22 identifies communication performed between the coupled server and another server 41 in the server group, as inter-server communication affected by the failure. Accordingly, the cloud management device 1 may accurately identify inter-server communication affected by the failure.

In addition, in the embodiment, the server group creation unit 14 creates the server group management table 16 with reference to the coupling link management table 12, and the physical path creation unit 17 creates the physical path table 18 with reference to the coupling link management table 12 and the group management table 16. Accordingly, the cloud management device 1 may reduce the time taken for creating the physical path table 18.

Note that although the cloud management device 1 has been described in the embodiment, an affected range identification program having functionalities similar to those of the cloud management device 1 may be obtained by implementing the configurations of the cloud management device 1 by software. Accordingly, a computer that executes the affected range identification program will be described.

FIG. 26 is a diagram illustrating a hardware configuration of a computer that executes an affected range identification program according to the embodiment. As illustrated in FIG. 26, a computer 50 includes a main memory 51, a central processing unit (CPU) 52, a LAN interface 53, and a hard disk drive 54. The computer 50 also includes a super input output (IO) 55, a digital visual interface (DVI) 56, and an optical disk drive (ODD) 57.

The main memory 51 is a memory that stores programs, results at certain points in programs, and the like. The CPU 52 is a central processing device that reads a program from the main memory 51 and executes the program. The CPU 52 includes a chip set including a memory controller.

The LAN interface 53 is an interface for coupling the computer 50 to another computer via a LAN. The HDD 54 is a disk device that stores programs and data, and the super IO 55 is an interface for coupling a mouse, a keyboard, and the like. The DVI 56 is an interface that couples a liquid crystal display device, and the ODD 57 is a device that reads and writes data to and from a digital versatile disk (DVD).

The LAN interface 53 is coupled to the CPU 52 by PCI Express (PCIe), and the HDD 54 and the ODD 57 are coupled to the CPU 52 by serial advanced technology attachment (SATA). The super IO 55 is coupled to the CPU 52 by a low pin count (LPC).

Further, the affected range identification program that is executed in the computer 50 is stored in a DVD, is read from the DVD by the ODD 57, and is installed in the computer 50. Alternatively, the affected range identification program, which is stored in a database of another computer system coupled via the LAN interface 53, and the like, is read from the database and the like, and is installed in the computer 50. Further, the installed data processing program is stored in the HDD 54, is read onto the main memory 51, and is executed by the CPU 52.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
in an information processing system including a plurality of information processing devices and a plurality of relay devices that relay communication between the information processing devices, grouping the plurality of information processing devices into groups each including one or more information processing devices which are each coupled via one link to an identical set of edge relay devices common to all the one or more information processing devices;
upon being provided with information on a failure that has occurred in the information processing system, identifying an inter-group communication between a pair of groups affected by the failure with reference to information on communication paths each coupling the pair of groups; and
identifying an inter-device communication between a pair of information processing devices that is affected by the failure, with reference to information on the identified inter-group communication and information on information processing devices in the pair of groups.

2. The non-transitory, computer-readable medium of claim 1, wherein the identifying the inter-group communication includes determining whether there is a spare path through which the identified inter-group communication is performed without being affected by the failure; and
the identifying the inter-device communication is performed when there is no spare path.

3. The non-transitory, computer-readable medium of claim 1, wherein
the identifying the inter-device communication includes identifying, when a failure has occurred in a link that couples an information processing device and an edge relay device, the inter-device communication with reference to information on the identified inter-group communication and information on information processing devices coupled to the link, among information processing devices in the pair of groups.

4. The non-transitory, computer-readable medium of claim 1, wherein
the identifying the inter-device communication includes identifying, when a failure has occurred in a link that couples a first information processing device and an edge relay device, a communication with a second information processing device with which the first information processing communicates within a group, as the inter-device communication.

5. The non-transitory, computer-readable medium of claim 1, the process further comprising identifying an inter-virtual machine communication between virtual machines that is affected by the failure, with reference to information on virtual machines that operate on each information processing device.

6. The non-transitory, computer-readable medium of claim 1, the process further comprising:
creating association information for associating the plurality of relay devices with the groups, with reference to link information including information on links coupled to each relay device and information on links coupled to each information processing device, and
creating information on communication paths between the groups with reference to the created association information and the link information.

7. An apparatus comprising:
a memory configured to store information on an information processing system including a plurality of information processing devices and a plurality of relay devices that relay communication between the information processing devices; and
a processor coupled to the memory and configured to:
with reference to the information in the memory, group the plurality of information processing devices into groups each including one or more information processing devices which are each coupled via one link to an identical set of edge relay devices common to all the one or more information processing devices,
upon being provided with information on a failure that has occurred in the information processing system, identify an inter-group communication between a pair of groups affected by the failure with reference to information on communication paths each coupling the pair of groups, and
identify an inter-device communication between a pair of information processing devices that is affected by the failure, with reference to information on the identified inter-group communication and information on information processing devices in the pair of groups.
